(19) United States
(12) Patent Application Publication
(10) Pub. No.: US 2008/0288870 A1
(43) Pub. Date: Nov. 20, 2008

(54) SYSTEM, METHODS, AND APPARATUS FOR MULTI-USER VIDEO COMMUNICATIONS

(76) Inventors: Yu Brian Zheng, Walnut, CA (US); Kan Wang, Corona, CA (US); Calvin Chee Keung Lee, Walnut, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/777,952

(22) Filed: Jul. 13, 2007

Related U.S. Application Data
(63) Continuation-in-part of application No. 11/748,428, filed on May 14, 2007.

(51) Int. Cl. G06F 3/00; G06F 15/16

(52) U.S. Cl. 715/719; 709/231

(57) ABSTRACT

A computer software product, methods and apparatus for improved video communications are provided. In one embodiment, an apparatus is provided that is configured to allow multi-user video communication. The video communications are streamed to and stored on a server device on a network. In one embodiment, the server device is configured to associate multiple video streams to a thread and allow users access to stored video content and associated files. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### RELATED CASES

This is a continuation-in-part of co-pending Ser. No. 11/748,428, filed May 14, 2007, whose entire disclosure is incorporated by this reference as though set forth fully herein.

### FIELD OF THE INVENTION

The present invention generally relates to video communications. More particularly, the invention concerns a system, methods, and apparatus for online multi-user video communications.

### BACKGROUND OF THE INVENTION

Modern communications systems have become commonplace in our society. From ecommerce to cell-phones to email communication networks have changed the way we live. With the advent of cellular telephones and the related infrastructure, communications have become more immediate. A communication user may be reached virtually anywhere at any time. Other forms of more immediate communications include instant messaging and text messaging.

Other forms of communications may include more of a time delay. With email a user may reply to an email when ever they wish. Email is limited with respect to the user's experience since it primarily contains text that a user reads. While it is true that most email systems additionally allow for attachments, such as files, these attachments may, or may not comprise the message being communicated. Forms of video communications exist where a user send video through the use of a camera. Most of these video communications platforms comprise relatively immediate communications in the form of “video chat”. For example, a number of commercial internet “messengers” include video. One limitation inherent in these messengers is the video content is not captured on either end of the conversation. In a situation where important discussions are occurring, there is no record of the substance of what transpired. Further, these messenger applications typically have no ability to playback or forward the video content to other interested parties.

In many contexts it would be useful to have a video-mail system which allows users to communicate more effectively. Therefore there exists a need for a system, methods, and apparatus for improved video communications.

### SUMMARY OF THE INVENTION

The present invention provides a system, apparatus and methods for overcoming some of the difficulties presented above. In an exemplary embodiment, a method of facilitating video communications is provided. In this embodiment, a first electronic device is configured to include a graphical user interface. In various embodiments, the graphical user interface may include a number of controls and input sections. One control present on the graphical user interface is a video control interface that allows a user to stream video to a second electronic device on the network. In this embodiment, the user interface additionally contains a recipient section allowing a user to designate a recipient of the video stream. Once the video is initiated, a camera connected to the electronic device is activated and video is streamed to a second device on the network. As further described below the second electronic device may be a server where the video is stored. Once the video has been transferred to the second device a notification is sent that the video has been stored.

In a another embodiment, a method is provided that allows a user to associate other electronic files to the video. In this embodiment, the user interface includes a control for selecting a file. When video is streamed to the server, the file is transferred to the server where it is associated to the video stream. Further embodiments provide for association of files to the video through a database. In an exemplary embodiment, the second electronic device associates a plurality of video streams to a thread. The thread may contain a series of video correspondences between users of electronic devices. Additionally, other items such as electronic files, audio and the like may be associated to the thread. One feature of this embodiment is that the thread may be transferred to an electronic device on the network where a user may select portions of the thread to view. Additionally, in some embodiments, controls are provided for a user may to forward a portion of the thread to another electronic device.

In a still further embodiment, an electronic device is provided. In this embodiment, the electronic device includes a video display device where a graphical user interface may be displayed. The graphical user interface consisting of at least a video control and an input section for designating a recipient of a video message. The electronic device having a connection to a camera suitable for streaming video to another electronic device on a network. In this embodiment, the device is configured to stream a video message to a second device where the second device stores the video message. The second device then sends a notification to the recipient indicating that the video has been stored and is available for viewing.

One feature of this embodiment is that it allows for a more persistent record of a video communication by storing the contents and related documents on an electronic device on a network where they can be later accessed. Further, by associating a plurality of videos to a thread a user may select a portion of the thread for viewing or forwarding to another device.

In another embodiment, a method of facilitating multi-user video communications is provided. In this embodiment, a method of facilitating video-based communications includes streaming video streams from at least two of a plurality of electronic devices to a server on a network, the streaming responsive to a video control on a graphical user interface on a display attached to each of the plurality of electronic devices, and the streaming further responsive to a video camera attached to each of the at least two of the plurality of electronic devices. The video streams are then stored on the server. The stored video streams are associated to a thread on the server. The server notifies at least one client electronic device of the stored video streams and provides access to the thread to the client electronic device. In further embodiments, the graphical user interface includes a session identifier. In further embodiments, the graphical user interface includes a control for a token passing scheme. In further embodiments, the client electronic device includes a software module configured with an embedded browser control, the control configured to allow playback on a client electronic device.

In another embodiment, a server device for facilitating multi-user video communications is provided. In this embodiment, a server device for facilitating multi-user video communications includes a processor, a memory; and, a storage media. The storage media includes a set of machine executable instructions, the machine executable instructions including a configuration for controlling the server to receive a plurality of video streams and store the video streams to a thread on the storage media where the video streams originate from a plurality of electronic devices on a network. The electronic devices are configured to display a graphical user interface on a video display, wherein the graphical user interface includes a recipient section and a video control interface. The electronic devices are configured to stream video from a server that is responsive to the video control interface and a video camera, the server being further configured to notify a recipient of the stored video streams. The server is further configured to provide a client electronic device access to the thread.

In another embodiment, a computer software product is provided. The computer software product includes a physical storage media that includes a set of computer executable instructions. The instructions are capable of configuring a computer to provide a graphical user interface on at least two of a plurality of electronic devices, wherein the graphical user interface includes a recipient selection section and a video control interface. The instructions also configure a computer to stream video from the at least two of a plurality of electronic devices to a server on a network responsive to the video control interface and video cameras, the video cameras being attached to the at least two of a plurality of electronic devices. The instructions also configure a computer to store the video streams on the server and associate the stored video streams to a thread on the server. The instructions also configure a computer to notify a recipient of the stored video streams and provide a client electronic device access to the thread.

### BRIEF DESCRIPTION OF THE DRAWINGS

Various embodiments of the present invention taught herein are illustrated by way of example, and not by way of limitation, in the figures of the accompanying drawings, in which:

FIG. 1 Illustrates a communication network consistent with various embodiments;

FIG. 2 illustrates a client server communication network consistent with provided embodiments;

FIG. 3 illustrates an electronic device consistent with provided embodiments;

FIG. 4 illustrates another electronic device consistent with provided embodiments;

FIG. 5 illustrates a further electronic device and a computer software product consistent with provided embodiments;

FIG. 6 illustrates various advantages and features of the an enhanced video communication system;

FIG. 7 depicts the flow of one provided method of video communications;

FIG. 8 illustrates an exemplary embodiment of a graphical user interface;

FIG. 9 illustrates the flow of another provided method for video communications;

FIG. 10 illustrates another embodiment of a graphical user interface;

FIG. 11 depicts the flow of another provided method of video communications;

FIG. 12 is an exemplary illustration of features of various embodiments of video communications;

FIG. 13 illustrates the flow of another provided method of video communications;

FIG. 14 depicts the flow of a further provided method of video communications;

FIG. 15 illustrates another exemplary embodiment of a graphical user interface; and

FIG. 16 illustrates another exemplary embodiment of a provided graphical user interface;

FIG. 17 depicts the flow of another provided method of video communications.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Text based communications and to some extent voice based communications sometimes mask portions of a conversation. For example, in an email exchange or a cellular phone call a persons facial expressions are not apparent to the recipient. Video chat systems exist that overcome part of this limitation, but these programs are not persistent in their ability to store and later retrieve the video content. An object of the present invention is to provide a system, methods and apparatus that overcome some of these difficulties and provide a richer communication experience to the user. Additionally, since various embodiments provide for storage, association, and playback, the embodiments of the present invention are a significant improvement over existing communication technologies.

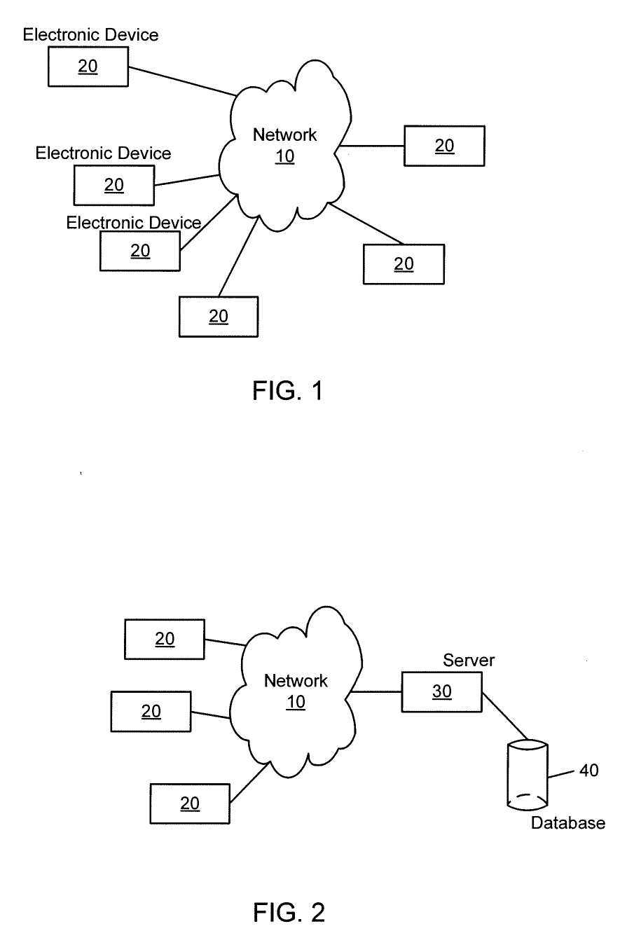

Various embodiments provide for video-centric communication between devices on a network. As illustrated in FIG. 1, a plurality of electronic devices 20 may be communicating through network 10. In one embodiment, network 10 is a peer-to-peer network where electronic devices 20 are peers communicating directly with each other across network 10. In another embodiment, illustrated in FIG. 2, one or more of electronic devices 20 may be a server 30, otherwise referred to herein as a server device. In this embodiment, network 10 may be considered a client-server network where communication between electronic devices 10 occurs through a server 30 on network 10. As further illustrated in FIG. 2, server 30 may be associated with a database 40 where communications and in various embodiments, files may be stored and associated with the video communications. In some embodiments, database 40 is located internally on server 30, in other embodiments it is located on another electronic device 20 on network 10.

As is known in the art, network 10 may employ wireless, wired, and optical media as the media for communication. Further, in some embodiments, portions of network 10 may comprise the Public Switched Telephone Network (PSTN). Networks, as used herein may be classified by range. For example, a local area networks, wide area networks, metropolitan area networks and personal area networks. Additionally, networks may be classified by communications media, such as wireless networks and optical networks for example. Further, some networks may contain portions in which multiple media are employed. For example, in modern television distribution networks, Hybrid-Fiber Coax networks are typically employed. In these networks, optical fiber is used from the “head end” out to distribution nodes in the field. At a distribution node communications content is mapped onto a coaxial media for distribution to a customer's premises. In many environments, the Internet is mapped into these Hybrid Fiber Coax networks providing high-speed Internet access to customer premises through a “cable-modem”. In these types of networks 10, electronic devices 20 may comprise computers, laptop computers, and servers 30 to name a few. Some portions of these networks may be wireless through the use of wireless technologies such as a technology commonly known as “WiFi” which is currently specified by the IEEE as 802.11 and its various variants which are typically alphabetically designated as 802.11a, 802.11b, 802.11g and 802.11n to name a few.

Portions of a network may additionally include wireless networks that are typically designated as “cellular networks”. In many of these networks, Internet traffic is routed through high-speed “packet-switched” or “circuit-switched” data channels that may be associated to traditional voice channels. In these networks 10, electronic devices 20, may include cell-phones, PDA's laptop computers, or other types of portable electronic devices. Additionally, metropolitan area networks may include “WiMax” networks employing an alternate wide area, or metropolitan area wireless technology. Further personal area networks are known in the art. Many of these personal area networks employ a frequency-hopping wireless technology known in the industry as “Bluetooth” others personal area networks may employ a technology known as Ultra-Wideband (UWB). The hallmark of personal area networks is their limited range, and in some instances very high data rates. Since many types of networks and underlying communication technologies are known in the art, various embodiments of the present invention will not therefore be limited with respect to the type of network or the underlying communication technology.

For purposes of clarity the term network as used herein specifically includes but is not limited to the following networks: a wireless communication network, a local area network, a wide area network, a client-server network, a peer-to-peer network, a wireless local area network, a wireless wide area network, a cellular network, a public switched telephone network, and the Internet.

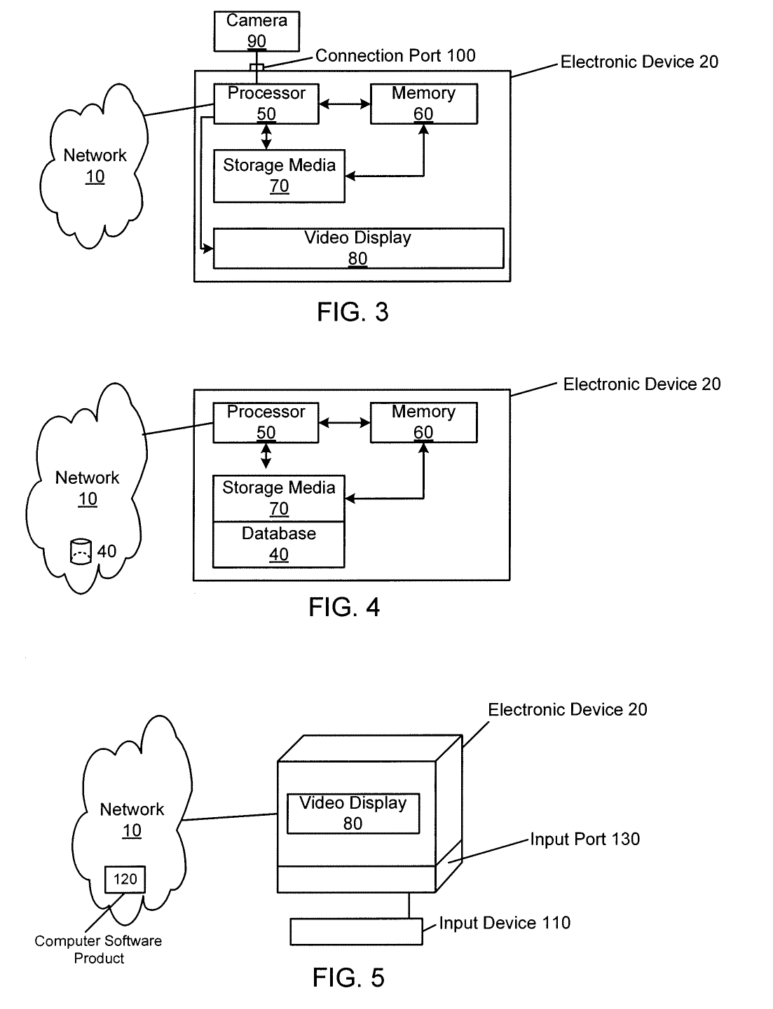

FIG. 3 illustrates a block diagram of an electronic device 20 consistent with provided embodiments. Electronic device 20 is suitable for connection to network 10. In wireless networks 10 this connection is through an antenna (not illustrated). In some embodiments, electronic device 20 comprises a processor 50, a memory 60, a storage media 70, a video display 80, and a connection port 100 suitable for connecting a camera 90 to electronic device 20. As is known in the art, electronic device 20 may comprise additional components, such as a microphone (not illustrated for convenience). Processor 50 may comprise any general purpose processor or in some embodiments, may be an application specific processor or even a digital signal processor. A number of memory technologies are known in the art and may be used to practice the current invention, therefore embodiments are not limited by the specific memory 60 used. In some embodiments, the video display 80 may be integrated into the electronic device (as illustrated), in other embodiments, video display 80 may be external and connected to the electronic device through a connection port such as a Digital Visual Interface (DVI), a High Definition Multimedia Interface (HDMI), a serial port, a parallel port, a S-Video port, a coaxial cable, a twisted pair connection port, or other port suitable for connecting video display 80 to electronic device 20. In an exemplary embodiment, connection port 100 is a Universal Serial Bus (USB) connection.

Like the above ports, there are various technologies that may be used to connect camera 90 to electronic device 20. Another exemplary connection technology includes a wireless personal area network technology like Bluetooth or UWB. When this technology is used to connect camera 90 to electronic device 20 connection port 100 comprises an antenna and transceiver. In some embodiments, storage media 70 is a hard-drive. Since other storage media 70, such as chip based media, are known in the art, the various embodiments are not limited with respect to the particular storage media technology employed. In some embodiments, storage media 70 contains a set of machine executable instructions that when executed by processor 50 configures electronic device 20 to provide improved video-centric communications across network 10. These video-centric communications consistent with various provided methods described below.

As used herein, electronic device 20 may comprise any electronic device capable of executing the provided configuration and methods for video communications. Specific electronic devices 20 may include but are not limited to a computer, a laptop computer, a desktop computer, a portable electronic device, and a personal digital assistant.

FIG. 4 further illustrates another embodiment of a provided electronic device 20. In this embodiment, electronic device 20 is capable of connecting to network 10 in a similar manner as described above. Electronic device 20 comprises a processor 50, a memory 60 a storage media 70. Like the above embodiments, electronic device 20 may include additional components which are not illustrated for convenience. Processor 50 may comprise any general purpose processor or in some embodiments, may be an application specific processor or even a digital signal processor. A number of memory technologies are known in the art and may be used to practice the current invention, therefore embodiments are not limited by the specific memory 60 used. In one embodiment, electronic device 20 is a server 30 and network 10 is a client-server network. In this embodiment, storage media may further include a database where video and associated files may be stored and associated with each other. As discussed above, in some embodiments database 40 is located within electronic device 20, or server 30, or may be located on another device on network 10. When configured as a server 30, electronic device 20 may or may not include a video display 80. Like the above embodiments, storage media 70 contains a set of machine executable instructions that when executed by processor 50 configures electronic device 20, or in some embodiments, server 30 to provide video communications across network 10. These video-centric communications consistent with various provided methods described below.

FIG. 5 illustrates another embodiment of electronic device 20 and an embodiment of a computer software product 120. In this embodiment, electronic device 20 is similar, in some respects, to the above embodiments but additionally includes an input device 110. In one embodiment electronic device 20 additionally includes an input port 120 suitable for accepting a computer software product 120. As is known in the art, input port 130 may be a port for a removable hard drive, a floppy disk port, an optical disk port, a port suitable to accept a computer software product 120 that comprises a chip based memory, or other port sufficient to accept computer software product 120.

In another embodiment (not shown) electronic device does not include input port 130 and computer software product 120 may comprise a storage media, like a hard drive, located in a device on network 10.

In one embodiment of computer software product 120, a storage media 70 contains a set of computer executable instructions that, when executed by a processor 50, configure electronic device 20 to provide video communications across network 10. These video-centric communications are consistent with various provided methods described below.

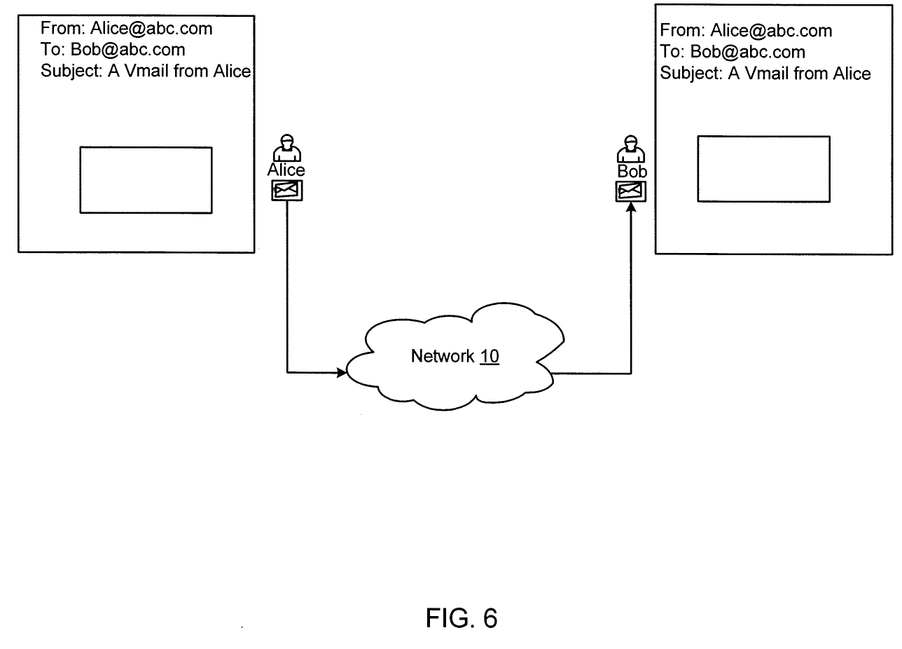

One feature of the present invention is illustrated in FIG. 6. In this illustration a first user “Alice” uses an electronic device 20 to send a v-mail to a second user “Bob”. as used herein the term “v-mail” refers to video-centric communications consistent with the provided embodiments. This illustration shows a video stream initiated by Alice on an electronic device 20 traversing a network 10, such as the Internet, being displayed on a second electronic device 20 owned by Bob.

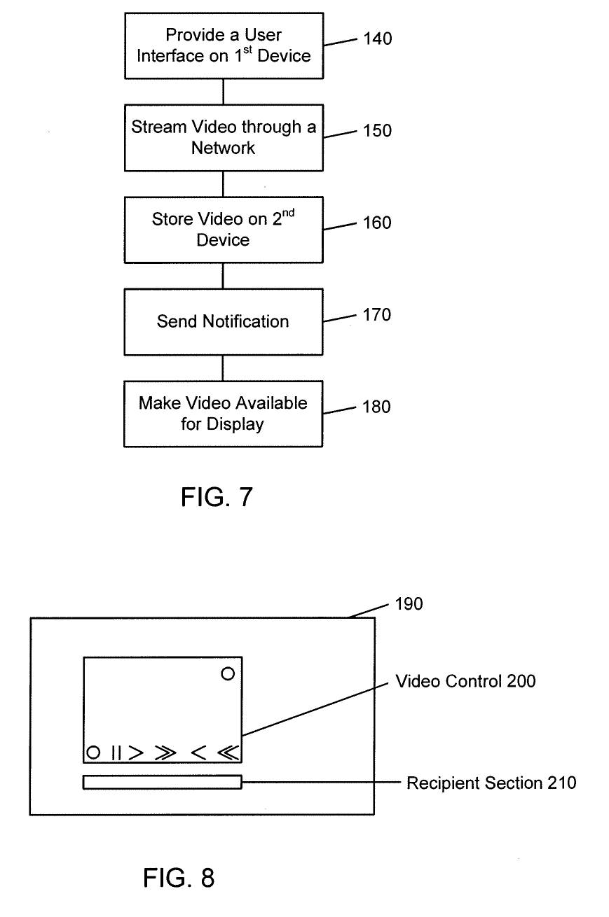

Various embodiments of provided methods are now discussed with reference to FIGS. 7-17. The configuration of an electronic device 20 for enhanced video communications begins in block 140 where a graphical user interface is provided on a first electronic device 20. An exemplary graphical user interface is illustrated in FIG. 8. The graphical user interface 190 may contain additional controls and sections but at a minimum contains a video control interface 200 and a recipient section 210. Exemplary controls within video control section may include record, stop, play, fast-forward, reverse, and fast reverse. Video control section allows a user to stream video from an electronic device 20 to a second electronic device 20 on network 10. As discussed above, second electronic device 20 may be a server 30. Recipient section 210 may comprise a text input box allowing a user to type a recipients address or other unique identifier such as a screen-name. In another embodiment, recipient section may include a selection window allowing a user to select receipient(s) from an address book.

Returning to FIG. 7, responsive to the appropriate video control, video is streamed to a second electronic device 20, such as a server 30, across network 10. One feature of this embodiment is that the video may be streamed to the second electronic device 20 without storage of the video on the first electronic device 20. In many situations, when the first electronic device 20 has limited storage capability this ability to stream video rather than record, locally save, then transfer is significantly advantageous. One example of this advantage is when the first electronic device is a cell phone or Personal Digital Assistant (PDA) with limited storage capacity. Flow continues to block 160 where the video is stored on the second device.

Another advantage of this embodiment is that it provides for a more persistent record of the communications since the video message is stored on the second device 20 and may be later retrieved. Flow continues to block 170 where the second electronic device 20 sends a notification that the video has been stored. In one embodiment, this notification is sent to the originator and the intended recipient(s). In another embodiment, this notification is sent only to the intended recipient(s). Various notification methods, such as text-message, simple message service, recorded phone call, fax, or email are known in the art. Various embodiments, are not therefore limited by the specific notification methodology. Flow then continues to block 180 where the video is made available for viewing by the recipient(s).

One feature of the present invention is that a user is notified of a video communication which they can view on an electronic device 20. In various embodiments the video may be streamed to the recipient's electronic device 20 or may be transferred as a file to the recipient's electronic device 20. One advantage of the present invention is that in some embodiments, a user may select to view a video as a stream when they are using an electronic device 20 with limited storage media 70, and may select to transfer the video as a file when using another electronic device 20 with more modest storage media 70. Since the second electronic device 20 stores the incoming video, it is available for viewing or downloading at a later time by the intended recipient.

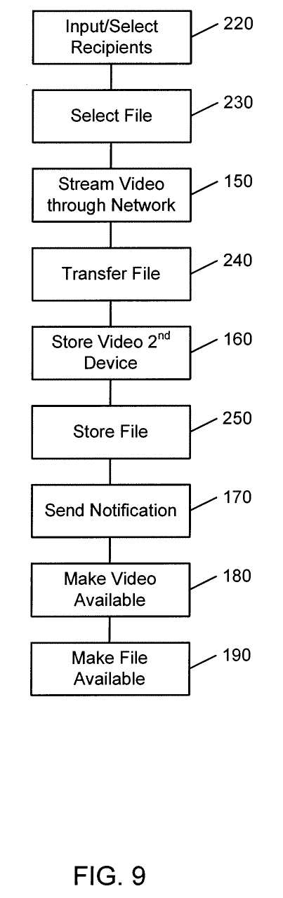

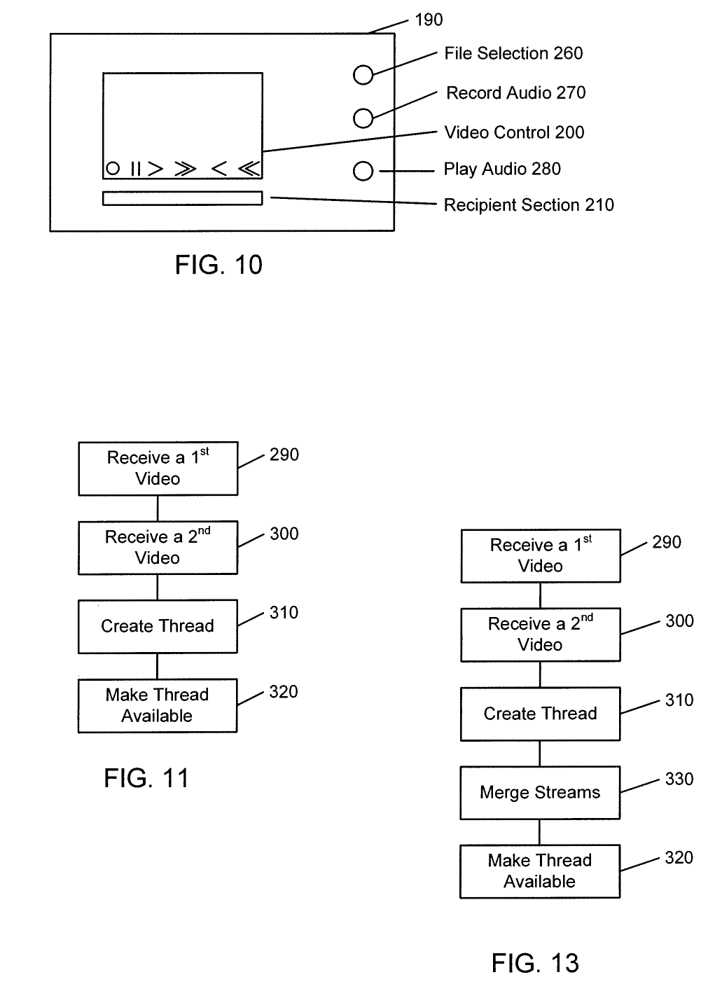

FIG. 9 illustrates another provided method for enhanced video communications. In this embodiment, recipients are selected or input in block 220. A file is associated with the video in block 230. In block 150 video is streamed to a second electronic device 20 on network 10. In block 240 the selected file is transferred to the second electronic device 20. In blocks 160 and 250 the video and the file are stored on the second electronic device 20. Like the above embodiment a notification is sent in block 170, and in blocks 180 and 190 the video and the file are made available to the recipient(s). The order of operation of many of the blocks described is not necessarily fixed. By way of example and not limitation, a file may be selected before recipients. A graphical user interface 190 consistent with this embodiment is illustrated in FIG. 10. This embodiment of a graphical user interface 190 is similar to the above embodiment with the addition of a control to associate a file with the video (depicted here as file selection control 260.) As used herein a file may comprise any form of electronic file such as a multi-media file; a voice recording; a video recording; a word processing file; an electronic photograph; a graphic file, and a drawing. In an exemplary embodiment, the user interface additionally contains a record audio control 270, where a user may record an audio file to be associated with the video. In a still further embodiment, illustrated in FIG. 10, the graphical user interface 190 may contain an optional play audio control 280 where the recorded audio file may be previewed before sending and where a received audio file may be selected for playback through speakers on the electronic device 20.

In embodiments where the second electronic device 20 is a server 30, the server 30 may associate the file to the video through the use of a database 40 located on the server. In other embodiments, the database may be located on another electronic device 20 on the network.

In some embodiments, the graphical user interface 190 includes a web browser-based interface. In some embodiments, the graphical user interface 190 is independent of a web browser-based interface. In some embodiments, the graphical user interface 190 includes an instant message interface. In some embodiments, the graphical user interface 190 includes a video mail (vmail) interface.

In some embodiments, the graphical user interface 190 includes a privacy control (not shown). In an exemplary embodiment, the privacy control may prevent viewing of video and opening of associated files by users other than the initial intended recipients. For example, if a user selects the privacy option when streaming video to a list of recipients and an intended recipient forwards the video to a user not on the initial recipient list, the privacy control may prevent their electronic device from playing back the video or in some instances, opening files associated with the video. In another embodiment, the privacy control acts as an access control on the second device. In this embodiment, when a video is made available to the recipients, all other users are restricted from transferring or initiating streaming of the video.

In some embodiments, the graphical user interface 190 includes a session identifier (not shown). The session identifier is a unique reference to a thread.

In some embodiments, the graphical user interface 190 includes a control for a token passing scheme (not shown). In an exemplary embodiment, the token passing scheme control allows an electronic device to instruct the server 30 the order of priority in which a token is passed from one electronic device to another thereby forming a queue for the plurality of electronic devices. In the order provided by the token passing scheme control, the server 30 can pass a token to the next electronic device in the queue. The video stream from the token-bearing electronic device is stored on the server 30. The video stream from a non-token-bearing electronic device is ignored by the server 30 or, alternatively, discarded by the server 30.

The token passing scheme can be based on any algorithm for ordering a queue known to those skilled in the art. In an exemplary embodiment, the token passing scheme is based on a first in time priority, where the first requester for a token is the first to obtain a token. In another exemplary embodiment, the token passing scheme is based on a user-defined scheme, where a user provides the order by which the token should be passed among requesters. In an exemplary embodiment, the token passing scheme is further based on a time-limit scheme, where a token is held by a requester for a determined time and then passed to the next requester in the queue.

FIG. 11 illustrates another method consistent with various provided embodiments. A second electronic device 20, such as a server 30, receives and stores a first video message in block 290. The video message having a sender and recipients(s), and as discussed above may have files, audio, and text associated with the video. In block 300 a second video message is received by the second electronic device 20. The second electronic device 20 then associates the first and second messages, files and text if present to a thread in block 300. This thread then becomes part of a persistent history of communications between the users. In block 320 portions of the thread are made available to the various recipients.

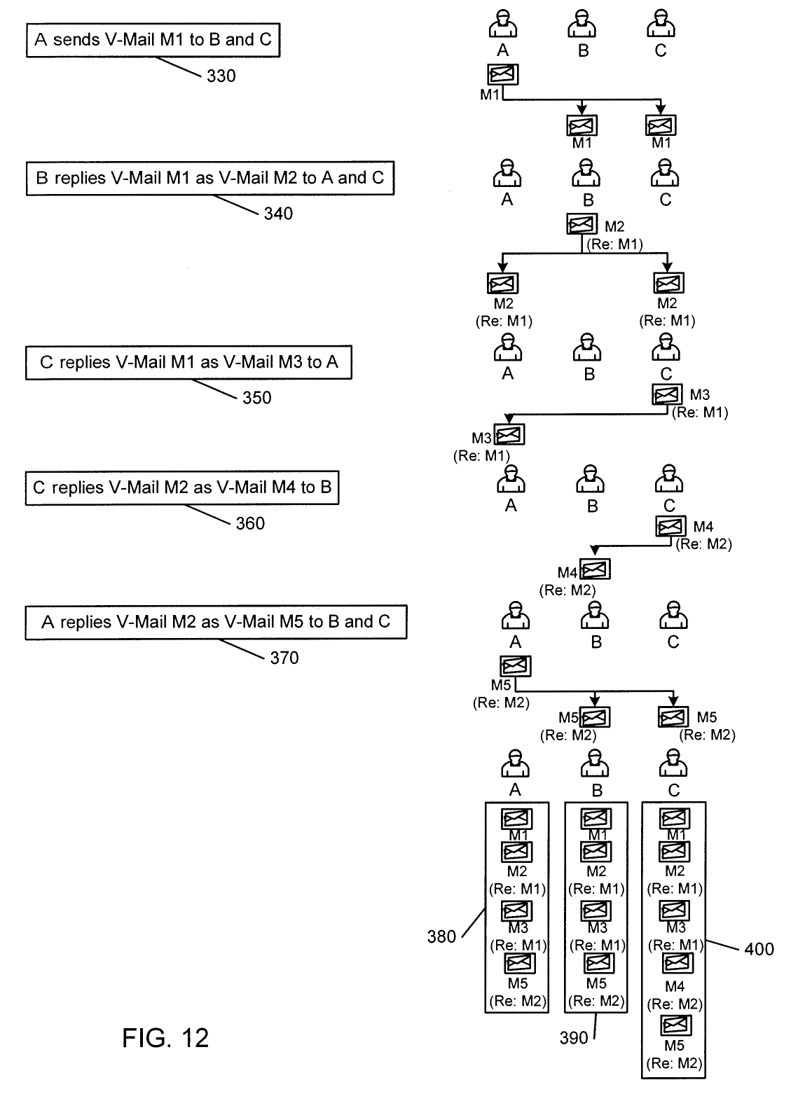

By way of example and not limitation, as illustrated in FIG. 12, in block 330 user A sends a video-mail “v-mail” M1 to users B and C. In block 340, user B replies to v-mail M1 by sending v-mail M2 to both A and C. In block 350 user C replies to the first v-mail M1 by sending v-mail M3 only to user A. In block 360 user C replies to v-mail M2 by sending v-mail M4 only to user B. In block 370 user A responds to v-mail M2 by sending v-mail M5 to both user B and user C. In this example, the second electronic device may create a number of threads. As shown thread 380 is associated to user A and references v-mail M1, M2, M3, and M5 since user A was not a recipient of v-mail M4. Thread 390 is associated to user B and contains v-mail M1, M2, M4, and M5 since user B was not a recipient of v-mail M3. In like manner, thread 400 is associated to user C and would contain all v-mail messages in the exchange. In an embodiment without a privacy control or where it was not selected, user C may forward v-mail M3 to user B, where it would be added to thread 390 and user B would have access to its contents. In an embodiment where v-mail M3 was sent by user C to user A with a privacy control selected, user B would not have access to the v-mail even if forwarded to them by user A.

Another embodiment is illustrated in FIG. 13. This embodiment is similar in many respects to the above embodiment where is begins in block 290 where the second electronic device 20 receives a first video stream and in block 300 receives a second video stream. Flow continues to block 310 where a thread is created. In this embodiment, the video streams are merged in block 330, and the thread is made available in block 320. The merger of video streams, as used herein, may consist of associating the streams for sequential playback, or it may involve rendering the contents of the video streams into a single video file. In some embodiments, advertising content may be added to the video streams. In one exemplary embodiment containing advertising content, the additional content is superimposed within a video stream as an additional frame or sequential frames within the video. In another embodiment, the advertising content comprises an additional video that is played between the content of sequential v-mail messages within a thread. In a still further embodiment, the advertising content comprises a logo or other image overlaid onto a portion of a frame or frames of the video message.

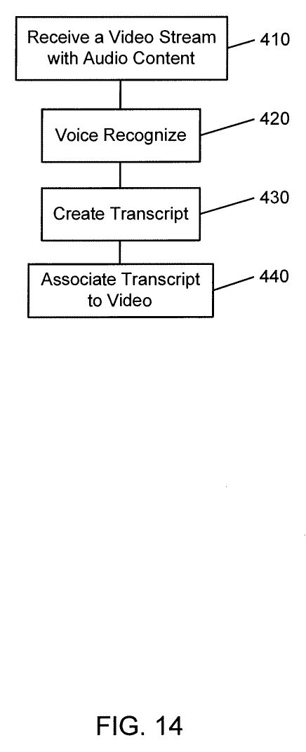

In another embodiment, illustrated in FIG. 14, a transcript of audio content from a video stream or other file containing audio is provided. Without loss of generality this embodiment is presented by using a video stream as an exemplar it is equally applicable to any content containing audio. In this embodiment, an electronic device 20 receives a video stream with audio content in block 410. In block 420 voice recognition technology is used to recognize the contents of the audio. Voice recognition technology is known in the art, the details of which are omitted for convenience. In block 430 a transcript of the audio content is created, and in block 440 the transcript is associated with the v-mail content it came from.

In another embodiment of a method for video based communication. The user interface contains the ability to display a thread in graphical form (see e.g. FIG. 12). In this embodiment, the graphical user interface includes a control that allows a user to select a portion of the thread to forward to other users.

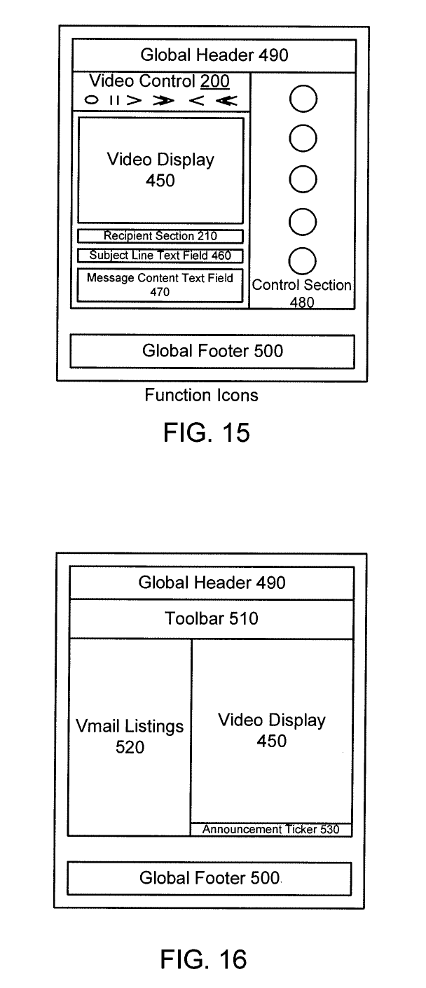

Additional functionality that a user interface 190 may optionally provide is illustrated in FIG. 15. In one embodiment, the user interface is configured to provide a video control section 200, a separate video display section 450, a recipient section 210, a subject field 460 where a user may enter a subject line, a message content text field 470 where text messages may be entered or displayed, a control section 480, a global header section 490 and a global footer section 500. The global header 490 and global footer section 500, in some embodiments, is used to display additional advertising content. Video display 450 is used to display video content and in some embodiments also is configured to graphically display threads. Control section 200 may include controls for file selection, recording audio files, playing audio files, and a privacy setting control as discussed above. It may additionally include controls for selecting a portion of a thread, forwarding a thread or a selected portion, and enabling a text input section. Further input sections (not illustrated) may include a carbon-copy section where a user can input or select recipients to cc, and a blind carbon copy section where a user can input or select recipients to bcc. It is important to note the placement of controls, inputs, and displays on a graphical user interface may take many forms. The invention is therefore not limited with respect to any specific arrangement or placement.

Another embodiment of a graphical user interface is illustrated in FIG. 16. In this embodiment, a global header 490, global footer 500, and video display 450 are provided and function similarly to the above embodiment. One distinction with video display 450 is that it is configured to provide a set of pup-up menus which can include such menu items as “View Video Mail”, “Record Video”, “Display Advertisement Video”, “Initiate Live Video Conference”, and “Video Clip Browsing” to name a few. In this embodiment toolbar 510 contains the above mentioned controls. V-mail listings section 520 in one embodiment, comprises an “In-box” where notifications are received. In other embodiments (not shown) V-mail listing section 520 may be configured to display a graphical representation of a thread. In still further embodiments, V-mail listing section 520 comprises an address book where recipient selection is simplified. This embodiment of a graphical user interface 190 additionally includes an announcement ticker section 530 where text and/or images may be displayed or scrolled.

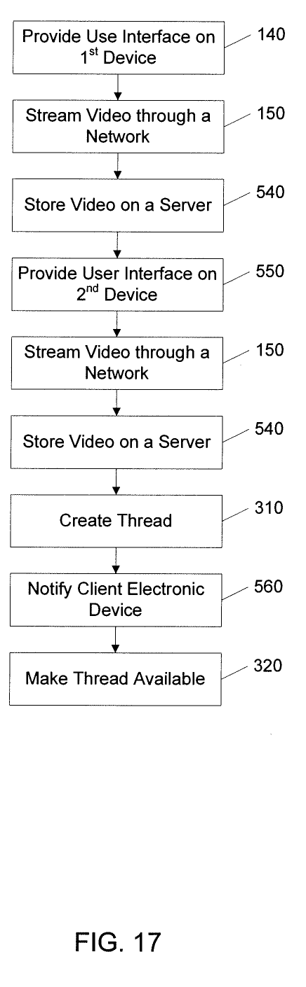

FIG. 17 illustrates another method consistent with various provided embodiments. Responsive to the appropriate video control, a first of a plurality of electronic devices 20 for enhanced multi-user video communications begins in block 140 where a graphical user interface is provided on a first electronic device. Video is streamed through a network 150. A server 30, receives and stores a first video message in block 540. Responsive to the appropriate video control, a second of a plurality of electronic devices 20 for enhanced multi-user video communications begins in block 550 where a graphical user interface is provided on a second electronic device. Video is streamed through a network 150. A server 30, receives and stores a second video message in block 540. The video messages having a sender and recipients(s), and as discussed above may have files, audio, and text associated with the video. The server 30 then associates the first and second messages, files and text if present to a thread in block 310. This thread then becomes part of a persistent history of communications between the users. The server then sends a notification to a client electronic device in block 560. In block 320 portions of the thread are made available to a client electronic device. A client electronic device can have a display. The display can have a graphical user interface. The client electronic device can have a video camera. As is known in the art, the client electronic device 20 may comprise additional components, such as a microphone (not illustrated for convenience). The client electronic device can have a software module. The software module can be configured with an embedded browser control. The embedded browser control can be configured to allow playback on a client electronic device. Any one or more of the plurality of electronic devices, including the first or second electronic device, can also be a client electronic device.

The present invention provides significant novel advantages over current forms of electronic communications. Thus, it is seen that a system, method and apparatus for video communications are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of facilitating video-based communications comprising:
streaming video streams from at least two of a plurality of electronic devices to a server on a network, the streaming responsive to a video control on a graphical user interface on a display attached to each of the plurality of electronic devices, the streaming further responsive to a video camera attached to each of the at least two of the plurality of electronic devices;
storing the video streams on the server;
associating the stored video streams to a thread on the server;
notifying a recipient of the stored video streams;
and providing a client electronic device access to the thread.

2. The method of claim 1, further comprising merging video streams associated to the thread.

3. The method of claim 2, wherein merging video streams comprises linking the video streams associated by the thread for sequential playback on the client electronic device.

4. The method of claim 2, wherein merging video streams comprises rendering the video content of the streams associated by the thread into a single video.

5. The method of claim 1, further comprising displaying the thread on the client electronic device.

6. The method of claim 1, further comprising displaying an advertisement on the client electronic device.

7. The method of claim 6, wherein the advertisement comprises a video displayed on the client electronic device.

8. The method of claim 6, wherein the advertisement comprises an image overlaid onto at least one frame of the video content.

9. The method of claim 6, wherein the advertisement comprises a logo superimposed onto a portion of at least one frame of the video content.

10. The method of claim 1, wherein each of the plurality of electronic devices, the client electronic device, and the server comprises a device selected from a group consisting of: a computer, a laptop computer, a desktop computer, a portable electronic device, a cell phone, and a personal digital assistant.

11. The method of claim 1, wherein the network comprises a network selected from a group consisting of: a wireless communication network, a local area network, a wide area network, a client-server network, a wireless local area network, a wireless wide area network, a cellular network, a public switched telephone network, and the Internet.

12. The method of claim 1, wherein the graphical user interface further comprises a session identifier.

13. The method of claim 1, wherein the graphical user interface further comprises a control for associating a file with the video stream, the method further comprising transferring the file from the at least one of the plurality of electronic devices to the server, storing the file on the server, and associating the file to the thread.

14. The method of claim 13, further comprising transferring the file to the at least one client electronic device.

15. The method of claim 14, wherein the file comprises a file selected from a group consisting of: a multi-media file; a voice recording; a video recording; a word processing file; an electronic photograph; a graphic file, and a drawing.

16. The method of claim 13, wherein the association of the file to the thread comprises associating the file with the video stream through a database on the server.

17. The method of claim 13, wherein the file is an audio file, the audio file being recorded from a microphone connected to the at least one of the plurality of electronic devices.

18. The method of claim 17, further comprising transferring the audio file to the client electronic device.

19. The method of claim 17, wherein the association to the thread comprises associating the audio file to the video stream through a database on the server.

20. The method of claim 17, wherein the graphical user interface further comprises a control allowing playback of the audio file on at least one of the plurality of electronic devices prior to transferring the audio file to the server.

21. The method of claim 1, wherein the graphical user interface further comprises a privacy control, the privacy control restricting the transfer of the video stream from the server.

22. The method of claim 21, wherein the privacy control restriction allows the video stream to be transferred from the server to a designated group of recipients.

23. The method of claim 21, wherein the graphical user interface further comprises a privacy control, the privacy control permitting the display of the video stream on the client electronic device.

24. The method of claim 1, wherein the graphical user interface further comprises a text input section, the method further comprising transferring the contents of the text input section to the server and displaying the contents of the text input section on the client electronic device.

25. The method of claim 1, further comprising wherein the graphical user interface further comprises a control for forwarding a selected portion of the thread to the client electronic device.

26. The method of claim 1, wherein the graphical user interface further comprises a browser based user interface.

27. The method of claim 26, wherein the browser based user interface is an embedded interface in a software program.

28. The method of claim 1, wherein the graphical user interface further comprises a user interface generated independent of a web-browser.

29. The method of claim 1, wherein the graphical user interface further comprises a control for a token passing scheme.

30. The method of claim 29, wherein the token passing scheme comprises a scheme selected from the group consisting of: a user-selected scheme, a first-in-first-out scheme, a user-defined priority scheme, and a time-limited scheme.

31. The method of claim 29, wherein streaming from a non-token-bearing electronic device is interrupted.

32. The method of claim 29, wherein streaming from a non-token-bearing electronic device is discarded by the server

33. The method of claim 1 wherein the client electronic device comprises an interface selected from the group consisting of: a browser interface, an instant message interface, and a vmail interface.

34. The method of claim 1, wherein the client electronic device further comprises a software module configured with an embedded browser control, the control configured to allow playback on a client electronic device.

35. A server device comprising:
a processor;
a memory; and,
a storage media, the storage media comprising a set of executable instructions, the machine executable instructions comprising a configuration for controlling the server to receive a plurality of video streams and store the video streams to a thread on the storage media, the video streams originating from a plurality of electronic devices on a network, the electronic devices configured to display a graphical user interface on a video display, wherein the graphical user interface comprises a recipient section and a video control interface, electronic devices being configured to stream video from server responsive to the video control interface and a video camera, the server being further configured to notify a recipient of the stored video streams, and the server being further configured to provide a client electronic device access to the thread.

36. The server device of claim 35, wherein the graphical user interface further comprises a control for associating a file with the thread, the server configuration further comprises a configuration to receive the file from the at least one of the plurality of electronic devices and store the file on the server.

37. The server device of claim 36, wherein the file comprises a file selected from a group consisting of: a multi-media file; a voice recording; a video recording; a word processing file; an electronic photograph; a graphic file, and a drawing.

38. The server device of claim 36, wherein the server configuration further comprises a configuration to associate the file with the thread through a database.

39. The server device of claim 38, wherein the database is located externally to the server on the network.

40. The server device of claim 35, wherein the graphical user interface further comprises a control for associating an audio file with the thread, the audio file being recorded from a microphone connected to the at least one of the electronic devices, the server configuration further comprising receiving the audio file from the electronic device and storing the audio file.

41. The server device of claim 40, wherein the server configuration further comprises a configuration to associate the audio file to the thread through a database.

42. The server device of claim 41, wherein the database is located externally to the server on the network.

43. The server device of claim 35, wherein the graphical user interface further comprises a control allowing playback of audio on a client electronic device.

44. The server device of claim 35, wherein the graphical user interface further comprises a privacy control, the server configuration further comprising a configuration to restrict the transfer of the video associated with the thread from the server.

45. The server device of claim 44, wherein the privacy control restriction allows the video associated with the thread to be transferred from the server to a designated group of recipients.

46. The server device of claim 35, wherein the graphical user interface further comprises a privacy control, the server configuration further comprising a configuration to allow the display of the video associated with the thread based on the privacy control.

47. The server device of claim 35, wherein the graphical user interface further comprises a session identifier.

48. The server device of claim 35, wherein the graphical user interface further comprises a control for a token passing scheme.

49. The server device of claim 48, wherein the token passing scheme comprises a scheme selected from the group consisting of: a user-selected scheme, a first-in-first-out scheme, a user-defined priority scheme, and a time-limited scheme.

50. The method of claim 48, wherein streaming from a non-token-bearing electronic device is interrupted.

51. The method of claim 48, wherein streaming from a non-token-bearing electronic device is discarded by the server.

52. The server device of claim 35, wherein the server configuration further comprises a configuration for merging video streams associated to the thread.

53. The server device of claim 52, wherein the server configuration for merging comprises a configuration to link the video streams associated by the thread for sequential playback on a client electronic device.

54. The server device of claim 52, wherein the server configuration for merging comprises a configuration to render the video content of the streams associated by the thread into a single video.

55. The server device of claim 35, wherein the server configuration further comprises a configuration to provide a client electronic device access to the thread.

56. The server device of claim 35, wherein the server configuration further comprises a configuration to transmit an advertisement to a client electronic device.

57. The server device of claim 56, wherein the advertisement comprises an image overlaid onto at least one frame of the video content.

58. The server device of claim 56, wherein the advertisement comprises a logo superimposed onto a portion of at least one frame of the video content.

59. The server device of claim 35, wherein the graphical user interface further comprises a text input section, the server configuration further comprising a configuration to receive the contents of the text input section from at least one of the plurality of electronic devices and store the contents of the text input section on the server device.

60. The server device of claim 35, wherein the server configuration further comprises a configuration to transfer the thread to a client electronic device, the graphical user interface further comprising a control for forwarding a portion of the thread to another client electronic device.

61. The server device of claim 35, wherein the plurality of electronic devices and the server device comprise devices selected from a group consisting of: a computer, a laptop computer, a desktop computer, a portable electronic device, a cell phone, and a personal digital assistant.

62. The server device of claim 35, wherein the network comprises a network selected from a group consisting of: a wireless communication network, a local area network, a wide area network, a wireless local area network, a client-server network, a wireless wide area network, a cellular network, a public switched telephone network, and the internet.

63. The server device of claim 35, wherein the graphical user interface further comprises a browser based user interface.

64. The server device of claim 35, wherein the graphical user interface further comprises a user interface generated independent of a web-browser.

65. The server device of claim 35, wherein the graphical user interface further comprises an input section selected from a group consisting of: a subject section, a carbon-copy section, and a blind carbon-copy section.

66. The server device of claim 35, wherein the graphical user interface further comprises a control selected from a group consisting of: a reply control, a reply-to-all control, and a forward control.

67. A computer software product comprising:
a physical storage media comprising a set of computer executable instructions, the instructions capable of configuring a computer to:
provide a graphical user interface on at least two of a plurality of electronic devices, wherein the graphical user interface comprises a recipient selection section, and a video control interface;
stream video from the at least two of a plurality of electronic devices to a server on a network responsive to the video control interface and video cameras, the video cameras being attached to the at least two of a plurality of electronic devices,
store the video streams on the server;
associate the stored video streams to a thread on the server;
notify a recipient of the stored video streams; and,
provide a client electronic device access to the thread.

68. The computer software product of claim 67, wherein the instructions are further capable of configuring a computer to display the video streams associated with the thread on a video display.

69. The computer software product of claim 67, wherein the graphical user interface further comprises a control for associating a file with the thread, the configuration further comprising a configuration to transfer the file from one of the at least two of a plurality of electronic devices to the server.

70. The computer software product of claim 69, wherein the file comprises a file selected from a group consisting of: a multi-media file; a voice recording; a video recording; a word processing file; an electronic photograph; a graphic file, and a drawing.

71. The computer software product of claim 69, wherein the server is configured to associate the file with the thread through a database.

72. The computer software product of claim 71, wherein the database is located externally to the server on the network.

73. The computer software product of claim 67, wherein the graphical user interface further comprises a control for associating an audio file with the thread, the audio file being recorded from a microphone connected to at least one of the plurality of electronic devices, the configuration further comprising a configuration to transfer the audio file from the at least one of the plurality of electronic devices to the server.

74. The computer software product of claim 73, wherein the server is further configured to transfer the audio file a client electronic device.

75. The computer software product of claim 73, wherein the server is further configured to associate the audio file to the thread through a database.

76. The computer software product of claim 75, wherein the database is located externally to the server on the network.

77. The computer software product of claim 73, wherein the graphical user interface further comprises a control allowing playback of the audio on the at least one of the plurality of electronic devices prior to transferring the audio file to the server.

78. The computer software product of claim 67, wherein the graphical user interface further comprises a privacy control, the privacy control restricting the transfer of the video associated with the thread from the server.

79. The computer software product of claim 78, wherein the privacy control restriction allows the video associated with the thread to be transferred from the server to a designated group of recipients.

80. The computer software product of claim 67, wherein the graphical user interface further comprises a privacy control, the privacy control allowing the display of the video associated with the thread on a client electronic device.

81. The computer software product of claim 67, wherein the graphical user interface further comprises a session identifier.

82. The computer software product of claim 67, wherein the graphical user interface further comprises a control for a token passing scheme.

83. The computer software product of claim 82, wherein the token passing scheme comprises a scheme selected from the group consisting of: a user-selected scheme, a first-in-first-out scheme, a user-defined priority scheme, and a time-limited scheme.

84. The computer software product of claim 82, wherein streaming from a non-token-bearing electronic device is interrupted.

85. The computer software product of claim 82, wherein streaming from a non-token-bearing electronic device is discarded by the server

86. The computer software product of claim 67, wherein the server is further configured to merge video streams associated to the thread.

87. The computer software product of claim 86, wherein the configuration for merging video streams comprises a configuration to link the video streams associated by the thread for sequential playback on the video display.

88. The computer software product of claim 86, wherein the configuration for merging video streams comprises a configuration to render the video content of the streams associated by the thread into a single video.

89. The computer software product of claim 67, wherein the server is further configured to transfer the thread to a client electronic device.

90. The computer software product of claim 67, wherein the server is configured to transfer an advertisement to a client electronic device.

91. The computer software product of claim 90, wherein the advertisement comprises a video.

92. The computer software product of claim 91, wherein the advertisement comprises an image overlaid onto at least one frame of the video content.

93. The computer software product of claim 91, wherein the advertisement comprises a logo superimposed onto a portion of at least one frame of the video content.

94. The computer software product of claim 67, wherein the graphical user interface further comprises a text input section, the server configuration further comprising a configuration to receive the contents of the text input section from at least one of the plurality of electronic devices and transfer the contents of the text input section to a client electronic device.

95. The computer software product of claim 67, wherein the server configuration further comprises a configuration to transfer the thread to a client electronic device, and
wherein the graphical user interface further comprises a control for forwarding a portion of the thread to another client electronic device.

96. The computer software product of claim 67, wherein the plurality of electronic devices, the client electronic device, and the server device comprise devices selected from a group consisting of: a computer, a laptop computer, a desktop computer, a portable electronic device, a cell phone, and a personal digital assistant.

97. The computer software product of claim 67, wherein the network comprises a network selected from a group consisting of: a wireless communication network, a local area network, a wide area network, a wireless local area network, a client-server network, a wireless wide area network, a cellular network, a public switched telephone network, and the internet.

98. The computer software product of claim 67, wherein the graphical user interface further comprises a browser based user interface.

99. The computer software product of claim 67, wherein the graphical user interface further comprises a user interface generated by a stand-alone software application.

100. The computer software product of claim 67, wherein the graphical user interface further comprises an input section selected from a group consisting of: a subject section, a carbon-copy section, a blind carbon-copy section.

101. The computer software product of claim 67, wherein the graphical user interface further comprises a control selected from a group consisting of: a reply control, a reply-to-all control, and a forward control.
